(19) United States
(12) Patent Application Publication
(10) Pub. No.: US 2008/0145548 A1
(43) Pub. Date: Jun. 19, 2008

(54) Coating material

(76) Inventor: Robert John Bracher, Little Hampton (GB)

Correspondence Address: WOLF GREENFIELD & SACKS, P.C., 600 ATLANTIC AVENUE, BOSTON, MA, 02210-2206, US

(21) Appl. No.: 11/710,257

(22) Filed: Feb. 23, 2007

(30) Foreign Application Priority Data
Dec. 18, 2006 (GB) 0625177.1

(51) Int. Cl. C04B 7/32

(52) U.S. Cl. 427/397.7; 106/286.8; 106/692

(57) ABSTRACT

A premix for a coating material, comprising a lithium-containing silicate mineral, an hydraulic binder and a hardener for a water soluble silicate is provided. The premix can be mixed with water and a water soluble silicate to form a coating material that can be directly applied onto a variety of different substrates, and cured to form a coating.

### RELATED APPLICATIONS

This application claims priority to U.K. Application Serial No. 0625177.1, filed Dec. 18, 2006, entitled “Coating Material,” by Robert John Bracher, incorporated herein by reference.

### FIELD OF INVENTION

The present invention generally relates to coating materials, including but not limited to fire-resistant coating materials.

### BACKGROUND

The present invention relates to a novel coating. The coating is made from a silica-based composite material that can be directly applied onto a variety of different substrates. The invention also provides a premix that can be used in the preparation of this material, which comprises a lithium-containing silicate mineral, an hydraulic binder and a hardener for a water soluble silicate.

There are many different types of structures that require coatings, e.g. for the purpose of fire-proofing. For instance, upon exposure to heat, steel initially expands but then loses its strength dramatically at around 540° C. The steel frames of buildings must therefore be protected from such extreme heat, in order to hinder their collapse in the event of a fire. A dramatic example of this was seen in the fireproofing of the steel columns of the World Trade Center buildings, which seemingly contributed to preventing their immediate collapse in the fire resulting from the plane crashes on Sep. 11, 2001.

Concrete linings of traffic tunnels are also vulnerable to serious damage in the event of fires when vehicles carrying flammable hydrocarbons are involved in accidents inside the tunnels. Hydrates and unbound water in unprotected concrete can undergo sudden reaction in the heat of such fires, causing it to crack and spall off. The European Fire Tunnel Research Project led to building codes for the industry to avoid these effects.

Other structures that are commonly fireproofed include the interiors of aircraft and ships, and liquified petroleum gas (LPG) containers.

Consequently, there has been intensive interest in the development of fire-resistant coatings. For instance, 2-part epoxy resins have been used; however, these burn at a relatively low temperature and peel away easily from the metal work. Intumescent coatings are also known, which swell and foam upon exposure to heat, forming a protective layer that hinders thermal transfer to the underlying substrate. They may contain chemically bound water in the form of hydrates, this water being evolved as steam during foaming. Some intumescents are susceptible to environmental influences such as humidity, which can reduce or negate their ability to function.

Other materials used for fire resistant coatings include organic polymers such as polyvinylidene fluoride, which has been used in the interiors of aircraft and ships. However, thermal decomposition of this compound produces a mixture of smoke and highly toxic gases, which can cause hydrogen fluoride burns and corrosion.

It would thus be desirable to have a coating that provides an efficient thermally insulating layer, that does not itself burn easily and does not produce toxic fumes, smoke or carcinogens upon exposure to the heat of a fire.

### SUMMARY OF THE INVENTION

Accordingly, in a first aspect of the invention, there is provided a premix for a coating material, comprising a lithium-containing silicate mineral, an hydraulic binder and a hardener for a water soluble silicate.

In a second aspect of the invention, there is provided a kit comprising a premix according to the invention in its first aspect and a composition comprising a water soluble silicate.

In a third aspect of the invention, there is provided a coating material obtainable by combining the premix according to the invention in its first aspect with water and a water soluble silicate.

In a fourth aspect of the invention, there is provided a coating obtainable by curing a coating material according to the invention in its third aspect.

In a fifth aspect of the invention, there is provided a metal, wood or plasterboard substrate having a coating according to the invention in its fourth aspect.

In a sixth aspect of the invention, there is provided the use of a coating material according to the invention in its fourth aspect to form a fire-resistant coating.

In a seventh aspect of the invention, there is provided a method of making a premix for a coating material, comprising mixing together at least a lithium-containing silicate mineral, an hydraulic binder and a hardener for a water soluble silicate.

In an eighth aspect of the invention, there is provided a method of making a coating material, comprising a method of making a premix according to the invention in its seventh aspect, and mixing the premix with water and a water soluble silicate.

In a ninth aspect of the invention, there is provided a method of forming a coated substrate, comprising a method of making a coating material according to the invention in its eighth aspect, applying the coating material to the substrate and allowing the coating material to harden, optionally involving accelerating hardening by heating.

Preferred embodiments of the invention in any of its various aspects are as described below or as defined in the sub-claims.

### DETAILED DESCRIPTION

The coating of the invention is made by combining the inventive premix, preferably in the form of a fine dry powder, with water and a water soluble silicate to form a coating material. This material is applied to the substrate in question and cured. Generally, curing involves both drying and chemical reaction between one or more constituents of the premix and the water soluble silicate, thereby forming a coating that excels in hardness, toughness and its thermally insulating properties. Importantly, the coating does not generate fumes or smoke at high temperatures, but rather maintains its own integrity.

A key component of the inventive premix is the lithium-containing silicate mineral. Preferably, this is a lithium aluminium tectosilicate mineral, in particular a lithium-containing feldspathoid such as petalite (also known as castorite). Pure petalite could be used, but in one embodiment the petalite is incorporated into the premix together with at least one feldspar, preferably a sodium feldspar and a potassium feldspar. The petalite may also be used in combination with a lithian muscovite and/or lepidolite. Such combinations may be found in a lithian pegmatite.

Advantageously, a natural source of the lithium-containing silicate mineral is used with an Li₂O content of at least 1%, preferably at least 1.5%. The ratio of the total amount of lithium-containing silicate mineral in the source rock to total amount of feldspar may be at least 1:3, preferably at least 1:2, preferably at least 3:4, preferably in the range 3:4 to 1:1. Use of a material having a high lithium content appears to make a significant difference to the structure hardness and surface finishes of the resulting fire-resistant coating.

A petalite-containing material that can is especially effective in the present invention is the combined petalite-feldspar product referred to as “high-lithium feldspar” by Avalon Ventures Ltd., which is produced at its Separation Rapids property near Kenora in Ontario, Canada. This glass sand material has the following mineralogy and chemical specifications:

Mineralogy

| | |
|---|---|
| Quartz | 25% |
| Na-feldspar (albite) | 30% |
| Rb-K-feldspar (microcline) | 10% |
| Petalite (plus spodumene-quartz intergrowth) | 25% |
| Lithian muscovite (including some lepidolite) | 10% |
| Columbite-tantalite | trace |
| Cassiterite | trace |

Chemical Specifications

| | |
|---|---|
| SiO₂ | 77.7% |
| Al₂O₃ | 14.6% |
| Na₂O | 4.08% |
| K₂O | 1.59% |
| Li₂O | 1.57% |
| CaO | 0.16% |
| Rb₂O | 0.18% |
| Fe₂O₃ | 0.04% |
| P₂O₅ | 0.03% |
| TiO₂ | 0.02% |
| LOI | 0.40% |
| Ta₂O₅ | 28 ppm |
| Nb₂O₅ | 51 ppm |
| SnO₂ | 950 ppm |

A favoured range of “high-lithium feldspar” in the premix is 200-400 g/kg, especially 200-300 g/kg, especially 240-260 g/kg.

The inventive premix also comprises a critical binder, namely a hydraulic binder. In one embodiment, a calcium aluminate cement is used. Preferably, a cement is used that has at least 60%, preferably at least 65%, preferably at least 68%, preferably 68-80% alumina. Examples of useful sintered CACs include Secar® 71 (approximately 71% alumina) and Secar® 80 (approximately 80% alumina), available from Kerneos Inc., 1316 Priority Lane, Chesapeake, Va. 23324. Secar® 71 is particularly effective. In an embodiment, the binder is included in the premix in an amount of 220-300 g/kg, preferably 250-270 g/kg.

Sodium fluorosilicate (or sodium silicofluoride, Na₂SiF₆) may be included in the premix as a hardener, and optionally may allow etching of the surface of a metal being coated. The amount of sodium fluorosilicate is preferably at least 20 g/kg, preferably 100 g/kg or less, preferably 20-50 g/kg, preferably 20-30 g/kg.

The inventive premix may also comprise filler materials such as fused silica, basalt and granite, and calcined kaolin clay or mullite aggregate. A preferred example of the latter is Mulcoa® 47 from C-E Minerals, 901 East 8^{th} Avenue, King of Prussia, Pa. 19406, United States of America, which is 65% mullite, 20% glass and 15% cristobalite. The amount of each of these individual fillers in the premix is not critical, rather the total amount of fillers is advantageously in the range 300-450 g/kg, preferably 350-400 g/kg.

In an embodiment, the premix comprises a hardener for the water soluble silicate that forms acidic aluminium orthophosphate when exposed to alkaline silicate solutions. For instance, the hardener may be a modified aluminium polyphosphate having an Al₂O₃ content of 10-15% and a P₂O₅ content of 40-45%. Suitable such curing agents include the modified aluminium phosphates Fabutit® 574 and Fabutit® 758, available from Chemische Fabrik Budenheim KG, Rheinstrasse 27, D-55257 Budenheim, Germany. Preferably, this type of hardener is used in the premix in an amount of 3 to 6% by weight. It can be used in addition to or instead of other hardeners, including sodium silicofluoride.

In one embodiment, manganese dioxide is included in the premix. This is thought to convey increased hardness and reduce curing times. MnO₂ is preferably included in the premix an amount of 10-40 g/kg, preferably 20-30 g/kg.

The inventive premix may also comprise fumed silica, preferably around 4% or less by weight, as an interstitial filler and water absorber. Other optional ingredients include muscovite mica and phlogopite mica, the latter being a low density thermal insulator added in the final blending process to fill the interstitial spaces after co-grinding of the other constituents.

Optionally, hard mineral grit can be incorporated into many of the premixes in order to provide a non-slip coating. Alpha Star® from C-E Minerals is effective, being a homogeneous calcined high alumina aggregate.

The premix may be supplied as a kit with a composition comprising a water soluble silicate. This composition may be an aqueous solution of the silicate; alternatively, the water soluble silicate may be supplied in solid or gel form, and may be made up into an aqueous solution just prior to use. The concentration of the solution and ratio of premix to water soluble silicate can be adjusted to give a coating material of the required consistency. The water soluble silicate is preferably an alkali or alkaline earth metal silicate, preferably an alkali metal silicate, preferably potassium and/or sodium silicate, preferably potassium silicate.

Once made up ready for use, the coating material is convenient to handle and is virtually odourless. For some of the coating materials, mixing is in the same manner as commercial paints, to afford a viscous liquid state. Advantageously, an aqueous potassium silicate solution having a SiO₂:K₂O weight ratio of 1:2.0-2.3 and a viscosity of 20-1000 cps, preferably 20-100 cps, is used, such as K-66 potassium silicate. Alternatively, K-53 potassium silicate could be used if a softer material is desired, or K-84 potassium silicate could be employed to produce a more viscous material.

The inventive composite coating materials can be used to coat many different types of substrate, including metal (particularly steel and aluminium), wood and plasterboard. Loose surface material should be removed from the substrate to be coated, followed by degreasing. These composites can then be applied directly onto the substrate, for instance by brush painting or using a large bore air operated or airless spray gun. Because of its viscous nature, these inventive composites can be applied easily to both horizontal and vertical surfaces. With steel in particular, the coating can form a molecular bond with the surface and, after curing, can become extremely tough. For instance, when used to coat the inside of oil storage tanks, the sodium silicofluoride may cut through any small oil residues left in the tanks and assist in producing a complete molecular bond to steel.

Others of the composites comprise a high volume low-density mineral, which gives a much thicker consistency. These composites may be applied to the substrates in the same manner as cement render. The coating is softer and so suitable for use on non-traffic bearing surfaces.

As mentioned above, curing generally involves both drying and chemical reaction between one or more constituents of the premix and the water soluble silicate, for instance between the potassium silicate and sodium silicofluoride, modified aluminium phosphate and MnO₂. The curing process may take around 24-48 hours at 20° C.; the chemical reaction may occur in the first few hours, with evaporation of water to dryness taking the remaining time. The curing process may be accelerated by heating; for instance, curing at 80° C. may allow sufficient dryness to be achieved in around 8 hours or less.

The resulting coatings may have one or more of the following advantageous properties: they are very hard, preferably having a hardness of at least 4 Mohs, preferably at least 5 Mohs, preferably at least 6 Mohs, preferably 5-7 Mohs. They are also very tough and flexible and have high tensile strength. The coated substrates can be heated and subsequently cooled in a localised area and will suffer no cracking and no detachment from the substrate surface. They are thermally insulating and can withstand exposure to 500° F. (260° C.), preferably 1200° F. (645° C.), for at least 30 minutes without suffering any substantial deterioration and without evolving any fumes or smoke. They also do not dissolve in the marine environment and are very inedible to plants, underwater vegetation, marine borers and crustaceans, making them particularly suitable for fire-proofing underwater surfaces of ships.

Optionally, a silicone liquid can be brushed or sprayed onto the coatings to replace some of the water evaporated by curing and to seal them. This affords an additional benefit for coatings of ships, making them less vulnerable to marine growths and crustaceans adhering to the surface at all. In other words, these coatings are non-foul (too slippery for marine growths to attach to the surface), contrasted with simple ante-fouling coatings that merely poison the growths once they have attached.

In unstable applications, reinforcing fibers may advantageously be included in the coating material, such as basalt fibers.

The following examples are intended to demonstrate the invention but are not intended to limit the invention in any manner.

### EXAMPLE 1

A base composition was formulated with the following components:

| Component | Amount (g) |
|---|---|
| “High Lithium Feldspar” | 250 |
| Secar ® 71 | 260 |
| Basalt powder (63 microns) | 140 |
| Granite powder (63 microns) | 140 |
| Mulcoa ® 47 | 100 |
| Fabutit ® 574 | 60 |
| Sodium silicofluoride | 25 |
| Manganese dioxide (MnO₂) | 25 |

The above-mentioned ingredients were ground together in a ceramic ball mill at 100 rpm for 25 minutes. 700 g K-66 potassium silicate solution was then added and mixed to form a coating material of the invention, which was subsequently applied to a substrate and cured.

The resulting coating withstands prolonged exposure to 500° F. (260° C.) with no damage or deterioration.

### EXAMPLE 2

A coating was prepared in the same manner as Example 1, except that, before addition of the potassium silicate, 100 g of hard mineral grit (having a hardness of 6 Mohs or more) was added and mixed. The resulting coating has non-slip properties.

### EXAMPLE 3

A base composition was formulated with the following components:

| Component | Amount (g) |
|---|---|
| “High Lithium Feldspar” | 250 |
| Secar ® 71 | 260 |
| Fused silica | 140 |
| Mulcoa ® 47 | 100 |
| Sodium silicofluoride | 25 |
| Manganese dioxide (MnO₂) | 25 |
| Muscovite mica | 100 |

The above-mentioned ingredients were ground together in a ceramic ball mill at 100 rpm for 25 minutes. 350 g phlogopite mica was then added and mixed per 1000 g of this ground mixture, without further grinding. Finally, 700 g K-66 potassium silicate solution was then added and mixed per 1000 g, and the resulting material applied to a substrate and cured to form a coating of the invention.

This coating withstands prolonged exposure to 1200° F. (645° C.) with no damage or deterioration.

### EXAMPLE 4

A coating was prepared in the same manner as Example 3, except that, before addition of the potassium silicate, 100 g of hard mineral grit (having a hardness of 6 Mohs or more) was added and mixed per 1000 g of the premix. The resulting coating has non-slip properties.

### EXAMPLE 5

A base composition was formulated with the following components:

| Component | Amount (g) |
|---|---|
| “High Lithium Feldspar” | 250 |
| Secar ® 71 | 260 |
| Fused silica | 140 |
| Mulcoa ® 47 | 100 |
| Sodium silicofluoride | 25 |
| Manganese dioxide (MnO₂) | 25 |
| Muscovite mica | 100 |

The above-mentioned ingredients were ground together in a ceramic ball mill at 100 rpm for 25 minutes. 200 g vermiculite (low density material), 50 g fumed silica and 350 g phlogopite mica was then added and mixed per 1000 g of this ground mixture, without further grinding. Finally, 700 g K-66 potassium silicate solution was then added and mixed per 1000 g, to form a coating material of the invention which was applied to a substrate and cured.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A premix for a coating material, comprising a lithium-containing silicate mineral, an hydraulic binder and a hardener for a water soluble silicate.

2. A premix as claimed in claim 1, wherein the lithium-containing silicate mineral is a lithium aluminium tectosilicate mineral.

3. A premix as claimed in claim 2, wherein the lithium-containing silicate mineral is a lithium-containing feldspar or feldspathoid.

4. (canceled)

5. A premix as claimed in claim 4, wherein the lithium-containing silicate mineral is petalite.

6. A premix as claimed claim 1, comprising a potassium feldspar or a sodium feldspar.

7-8. (canceled)

9. A premix as claimed in claim 1, wherein the hydraulic binder is a calcium aluminate cement.

10. (canceled)

11. A premix as claimed in claim 1, wherein the hardener for a water soluble silicate is sodium fluorosilicate.

12. A premix as claimed in claim 1, comprising a hardener for a water soluble silicate that forms acidic aluminium orthophosphate when exposed to alkaline silicate solutions.

13. (canceled)

14. A premix as claimed in claim 1, comprising manganese dioxide.

15. A premix as claimed in claim 1, comprising a finely divided material selected from the group consisting of granite, basalt, clay, mica and combinations thereof.

16. (canceled)

17. A premix as claimed in claim 1, further comprising a thixotropic agent.

18-24. (canceled)

25. A premix as claimed in claim 1, comprising low density mineral granules.

26. A premix as claimed in claim 1, comprising hard mineral grit.

27. (canceled)

28. A kit comprising a premix as claimed in claim 1 and a composition comprising a water soluble silicate.

29. A kit as claimed in claim 28, wherein the water soluble silicate is an alkali or alkaline earth metal silicate.

30-31. (canceled)

32. A kit as claimed in claim 28, wherein the composition comprises the water soluble silicate in solid or gel form.

33-49. (canceled)

50. A method of making a premix for a coating material, comprising mixing together at least a lithium-containing silicate mineral, an hydraulic binder and a hardener for a water soluble silicate.

51. A method as claimed in claim 50, comprising milling together at least a lithium-containing silicate mineral, an hydraulic binder and a hardener for a water soluble silicate.

52. A method of making a coating material, comprising a method of making a premix as claimed in claim 50, and mixing the premix with water and a water soluble silicate.

53. A method of forming a coated substrate, comprising a method of making a as coating material claimed in claim 52, applying the coating material to the substrate and allowing the coating material to harden, optionally involving accelerating hardening by heating.
